(19) United States
(12) Patent Application Publication
(10) Pub. No.: US 2009/0232556 A1
(43) Pub. Date: Sep. 17, 2009

(54) COUNTING METHOD OF MIXING TIME OF DEVELOPER

(75) Inventors: Hirotaka Fukuyama, Shizuoka (JP); Satoshi Itaya, Shizuoka (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/401,687

(22) Filed: Mar. 11, 2009

Related U.S. Application Data
(60) Provisional application No. 61/036,567, filed on Mar. 14, 2008.

(51) Int. Cl. G03G 15/08

(52) U.S. Cl. 399/236

(57) ABSTRACT

A driving time count is obtained by accumulating a multiplication value which is obtained by multiplying a driving time of a mixer by a coefficient corresponding to an operation of a developing roller. When the driving time count reaches a life threshold for judgment of a life of a developer, it is judged that the developer reaches its end of life.

### CROSS REFERENCE TO RELATED APPLICATION

This application is based upon and claims the benefit of priority from provisional U.S. Application 61/036,567 filed on Mar. 14, 2008, the entire contents of which are incorporated herein by reference.

### TECHNICAL FIELD

The present invention relates to a measuring apparatus of mixing time of developer, which manages whether a developing device used in an image forming apparatus, such as a copy machine or a printer, reaches a replacement timing.

### BACKGROUND

Among developing devices used in an image forming apparatus such as a copy machine or a printer, there is a device which is used while a toner cartridge filled with toner as a consumable is replaced. In such a developing device, in addition to the management of the replacement timing of the toner cartridge, it is necessary to manage the replacement timing of the developer or the replacement timing of the developing device. Hitherto, there is a device in which in order to manage the replacement timing of the developer or the developing device, the driving time of the developing device is counted, and when the accumulated count of the driving time reaches a predetermined specified time, it is judged that the developer or the developing roller reaches its end of life.

However, when an image forming apparatus has plural image forming speeds, or when the operation of a developing roller is changed with respect to the driving of a mixer, the degree of deterioration of the developer varies according to the image formation speed or the operation mode of the developing roller. When the image forming apparatus has the plural image forming speeds or the operation of the developing roller is changed, even if the accumulated count of the driving time of the developing device reaches the specified time, there is a possibility that the developer actually does not reach its end of life. There is a fear that even if the accumulated count obtained by simply accumulating the driving time of the developing device is compared with the specified time, the life of the developer can not be accurately obtained.

Even when the image forming apparatus has the plural image forming speeds, or even when the operation of the developing roller is changed with respect to the driving of the mixer, it is desired that the life of the developer is accurately judged.

### SUMMARY

In an aspect of the invention, judges the life of a developer accurately, prevents to replace a usable developer wastefully, improves the economic efficiency, and reduces the maintenance.

According to an aspect, a measuring apparatus of mixing time of developer includes a mixing member to mix the developer in a developing container, a developing member that has plural driving speeds and supplies the developer in the developing container to an image carrier, and an arithmetic member to multiply a driving time of the mixing member by a coefficient which is set correspondingly to an operation of the developing member in a period when the mixing member is driven, and to accumulate a multiplication count obtained by multiplication of the coefficient.

### DESCRIPTION OF THE DRAWINGS

FIG. 1 is a whole structural view showing an image forming apparatus of a first embodiment;

FIG. 2 is a schematic structural view showing a developing device of the first embodiment and a driving system of the developing device;

FIG. 3 is a graph showing a relation between driving time count and background fogging degree of the first embodiment;

FIG. 4 is an explanatory view showing a driving time count of a reference example of the first embodiment;

FIG. 5 is a flowchart showing measurement of the life of a developer of the first embodiment;

FIG. 6 is an explanatory view showing a calculation example of a driving time count of the first embodiment;

FIG. 7 is an explanatory view showing a calculation example of a driving time count of a comparative example of the first embodiment; and

FIG. 8 is an explanatory view showing a calculation example of a driving time count of a second embodiment.

### DETAILED DESCRIPTION

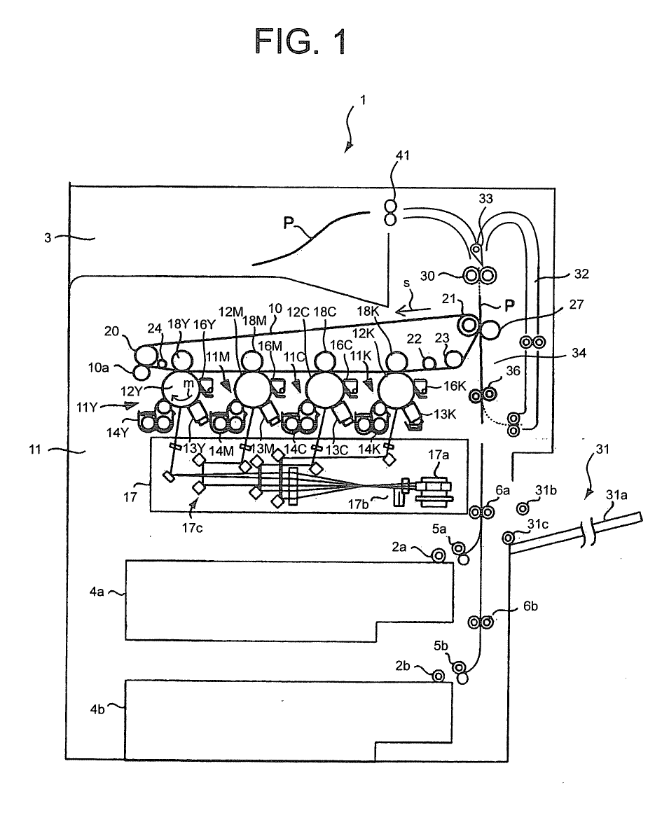

Hereinafter, a first embodiment will be described. FIG. 1 is a schematic structural view of a color printer 1 as an image forming apparatus of the first embodiment. The color printer 1 is of a train-of-four tandem type. The color printer 1 performs printing at plural printing speeds. For example, when printing is performed on standard paper with a weight per unit area of about 64 to 80 g/m², the color printer 1 sets the printing speed at 150 mm/sec. For example, when printing is performed on thick paper with a weight per unit area heavier than 80 g/m², the color printer 1 sets the printing speed at 75 mm/sec.

The color printer 1 includes a paper eject portion 3 at an upper part. The color printer 1 includes four sets of image forming stations 11Y, 11M, 11C and 11K disposed in parallel along the lower side of an intermediate transfer belt 10. The image forming stations 11Y, 11M, 11C and 11K respectively include photoconductive drums 12Y, 12M, 12C and 12K as image carriers. The respective image forming stations 11Y, 11M, 11C and 11K form toner images of yellow (Y), magenta (M), cyan (C) and black (K) on the respective photoconductive drums 12Y, 12M, 12C and 12K.

The respective photoconductive drums 12Y, 12M, 12C and 12K rotate in an arrow m direction. Charging chargers 13Y, 13M, 13C and 13K, developing devices 14Y, 14M, 14C and 14K, and photoreceptor cleaners 16Y, 16M, 16C and 16K are respectively disposed around the respective photoconductive drums 12Y, 12M, 12C and 12K along the rotation direction.

For the respective image forming stations 11Y, 11M, 11C and 11K, the photoconductive drums 12Y, 12M, 12C and 12K, the charging chargers 13Y, 13M, 13C and 13K, the developing devices 14Y, 14M, 14C and 14K, and the photoreceptor cleaners 16Y, 16M, 16C and 16K may be respectively united to form process cartridges. When the process cartridges are formed, the respective process cartridges are independently and integrally attached to and detached from the main body of the color printer 1.

Exposure lights by a laser exposure device 17 are irradiated between the charging chargers 13Y, 13M, 13C and 13K and the developing devices 14Y, 14M, 14C and 14K around the photoconductive drums 12Y, 12M, 12C and 12K. The laser exposure device 17 scans laser beams emitted from a semiconductor laser element in an axial direction of the photoconductive drum 12, and includes a polygon mirror 17a, an imaging lens system 17b, a reflecting mirror 17c and the like. Electrostatic latent images are respectively formed on the photoconductive drums 12Y, 12M, 12C and 12K by the irradiation of the exposure lights from the laser exposure device 17. The respective charging chargers 13Y, 13M, 13C and 13K and the laser exposure device 17 constitute a latent image forming portion.

The respective developing devices 14Y, 14M, 14C and 14K supply toners to the electrostatic latent images on the photoconductive drums 12Y, 12M, 12C and 12K, and visualize the electrostatic latent images. The respective developing devices 14Y, 14M, 14C and 14K perform development with a two-component developer containing a carrier and a toner of each of yellow (Y), magenta (M), cyan (C) and black (K).

The intermediate transfer belt 10 is stretched by a backup roller 21, a driven roller 20 and first to third tension rollers 22 to 24, and is rotated in an arrow s direction. The intermediate transfer belt 10 is opposite to the photoconductive drums 12Y, 12M, 12C and 12K, and contacts therewith. Primary transfer rollers 18Y, 18M, 18C and 18K are provided at positions where the intermediate transfer belt 10 is opposite to the photoconductive drums 12Y, 12M, 12C and 12K. The respective primary transfer rollers 18Y, 18M, 18C and 18K primarily transfer the toner images formed on the photoconductive drums 12Y, 12M, 12C and 12K to the intermediate transfer belt 10. The respective photoreceptor cleaners 16Y, 16M, 16C and 16K remove and collect residual toners on the photoconductive drums 12Y, 12M, 12C and 12K after the primary transfer.

A secondary transfer roller 27 is opposite to the intermediate transfer belt 10 at a secondary transfer portion where the intermediate transfer belt is supported by the backup roller 21. In the secondary transfer portion, a specified secondary transfer bias is applied to the backup roller 21. When a sheet passes through between the intermediate transfer belt 10 and the secondary transfer roller 27, the toner image on the intermediate transfer belt 10 is secondarily transferred onto the sheet. The sheet P is supplied from a paper feed cassette 4a, 4b or a manual feed mechanism 31. After the secondary transfer is finished, a belt cleaner 10a cleans the intermediate transfer belt 10.

Pickup rollers 2a and 2b, separation rollers 5a and 5b, conveying rollers 6a and 6b, and a register roller pair 36 are provided from the paper feed cassettes 4a and 4b to the secondary transfer roller 27. A manual feed pickup roller 31b, and a manual feed separation roller 31c are provided from a manual feed tray 31a of the manual feed mechanism 31 to the register roller pair 36. A fixing device 30 is provided downstream of the secondary transfer portion along a direction of a longitudinal conveying path 34. The fixing device 30 fixes the toner image transferred to the sheet P by the secondary transfer portion to the sheet P. A gate 33 to distribute the sheet to a direction of a paper eject roller 41 or a direction of a re-conveying unit 32 is provided downstream of the fixing device 30. The sheet guided to the paper eject roller 41 is ejected to the paper eject portion 3. The sheet guided to the re-conveying unit 32 is again guided to the direction of the secondary transfer roller 27.

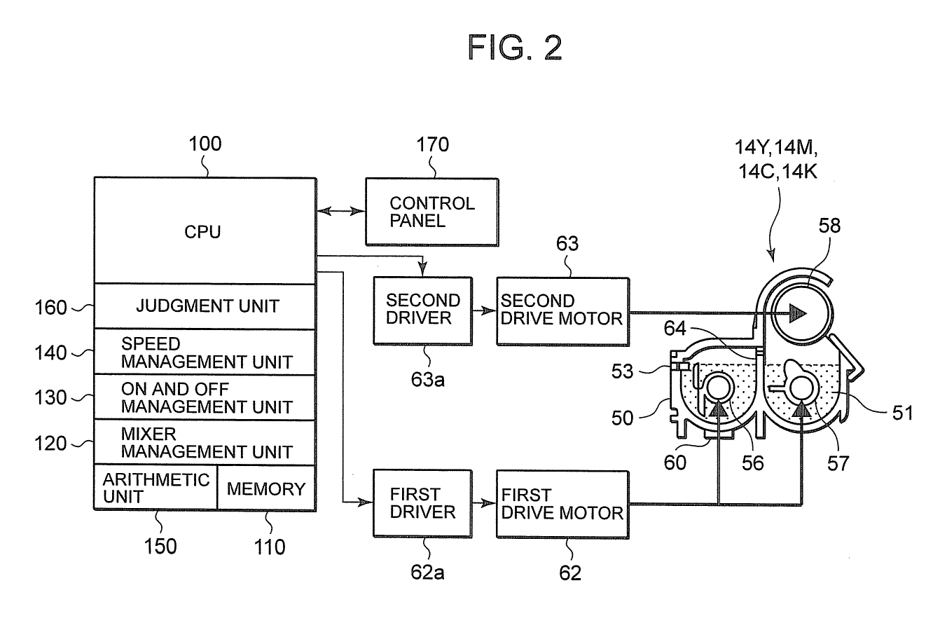

Next, the developing devices 14Y, 14M, 14C and 14K will be described. Since the developing devices 14Y, 14M, 14C and 14K have the same structure, common reference numerals are used and a description will be made. As shown in FIG. 2, each of the developing devices 14Y, 14M, 14C and 14K includes a case 50 which is a developing container and contains a two-component developer 51, a first and a second mixers 56 and 57 as a mixing member, a developing roller 58 as a developing member, and a toner density sensor 60.

The first mixer 56 and the second mixer 57 of the case 50 are partitioned from each other by a partition plate 64. The first and the second mixers 56 and 57 mix the developer 51, and circulate and convey the developer 51 in the case 50. The toner density sensor 60 is disposed at the bottom of the case 50. The toner density sensor 60 uses, for example, a permeability sensor. When the lowering of the toner density of the developer 51 in the case 50 is detected from the detection result of the toner density sensor 60, the toner is supplied from, for example, a toner cartridge to the case 50 according to the detection result. By this, the toner density of the developer 51 in the case 50 is kept constant.

The second mixer 57 mixes and conveys the developer 51, and supplies it to the developing roller 58. The developing roller 58 supplies the toner to the electrostatic latent images on the respective photoconductive drums 12Y, 12M, 12C and 12K, and forms the toner images on the photoconductive drums 12Y, 12M, 12C and 12K. The developer 51 passing the developing roller 58 is circulated and conveyed to the first mixer 56 side by the second mixer 57.

A new carrier is supplied to the case 50 from, for example, a carrier cartridge. In the supply of the new carrier, only the carrier may be supplied. Alternatively, the new carrier may be supplied by supplying a two-component developer containing a toner and a carrier. A discharge port 53 as a developer discharging member is formed at the side part of the case 50. The volume of the developer 51 in the case 50 is increased by the supply of the new carrier, and the excess developer is discharged from the discharge port 53 and is collected. In the case 50, the amount of the developer 51 is kept constant. In the case 50, the deteriorated old carrier is replaced little by little by the new carrier. The charge performance of the toner of the developer 51 in the case 50 is kept constant.

The first and the second mixers 56 and 57 are driven by a first drive motor 62 as a first driving member at a constant speed of, for example, 400 rpm. The first and the second mixers 56 and 57 are driven at the constant speed, and the height of the surface of the mixed and conveyed developer 51 is made constant. The variation in discharge amount of the excess developer from the discharge port 53 is suppressed, and the amount of the developer 51 in the case 50 is stabilized.

The developing roller 58 is driven by a second drive motor 63 as a second driving member. The driving speed of the developing roller 58 is changed according to the printing speed of the color printer 1 (rotation speed of the photoconductive drums 12Y, 12M, 12C and 12K). When printing is performed on standard paper, the driving speed of the developing roller 58 is 150 mm/sec. When printing is performed on thick paper, the driving speed of the developing roller 58 is 75 mm/sec. When the traveling distance of the developing roller 58 per unit time when printing is performed on the standard paper is made 1, the traveling distance of the developing roller 58 per unit time when printing is performed on the thick paper is ½.

A first driver 62a of the first drive motor 62 and a second driver 63a of the second drive motor 63 are respectively connected to a CPU 100 to control the color printer 1.

The CPU 100 includes a memory 110, a mixer management unit 120 to instruct the first driver 62a to drive the first motor 62, an on and off management unit 130 to instruct the second driver 63a to turn on and off the second motor 63, and a speed management unit 140 to instruct the second driver 63a to control the driving speed of the second motor 63.

The CPU 100 includes an arithmetic unit 150 as an arithmetic member to calculate the driving time count of the respective developing devices 14Y, 14M, 14C and 14K according to the operation of the second motor 63, and a judgment unit 160 as a judgment member to compare the calculation result of the arithmetic unit 150 with a life threshold in the memory 110 and to judge whether the developer 51 reaches its end of life. The CPU 100 controls a control panel 170 that performs input and output of data of the color printer 1 and displays the judgment result of the judgment unit 160.

The arithmetic unit 150 of the CPU 100 calculate a multiplication count from multiplies the driving time of the first and the second mixers 56 and 57 by a count coefficient. The count coefficient is a coefficient corresponding to the operation of the developing roller 58 in a period when the first and the second mixers 56 and 57 are driven. The arithmetic portion unit 150 accumulates the multiplication count and calculates a driving time count as an accumulated count.

The judgment of the life of the developer 51 of the developing devices 14Y, 14M, 14C and 14K will be described. The memory 110 stores the life threshold used for the judgment as to whether the developer 51 reaches its end of life. The memory 110 stores the driving time count as the calculation result of the arithmetic unit 150.

### (Setting of the Life Threshold)

When the developer 51 is deteriorated while a print job is being performed, the toner is adhered to a background portion where the toner image is not formed. When the background fogging degree as a toner adhesion degree to the background portion becomes large and the background fogging degree becomes, for example, 2 or more, it is judged that a replacement is necessary because of the developer 51 reaches its end of life. The driving time of the developing devices 14Y, 14M, 14C and 14K until the developer 51 reaches its end of life is weighted (multiplied by a count coefficient), and a driving time count obtained by accumulating the weighted driving time (multiplication count) is stored as the life threshold into the memory 110.

The setting of the life threshold will be described while using the developing device 14Y of yellow (Y). The developing device 14Y of yellow (Y) is replaced by a new one, and next, a print job is performed using JIS A4 size standard paper. In one print job, printing of five sheets is performed. Each time the printing of five sheets is performed, the deterioration degree of the developer 51 is measured. In the print job on the standard paper, the first and the second mixers 56 and 57 are driven at a constant speed, and the developing roller 58 is driven at a driving speed of 150 mm/sec. The count coefficient multiplied to the driving time of the developing device 14Y of yellow (Y) is set to, for example, 4. The numerical value of the count coefficient is not limited.

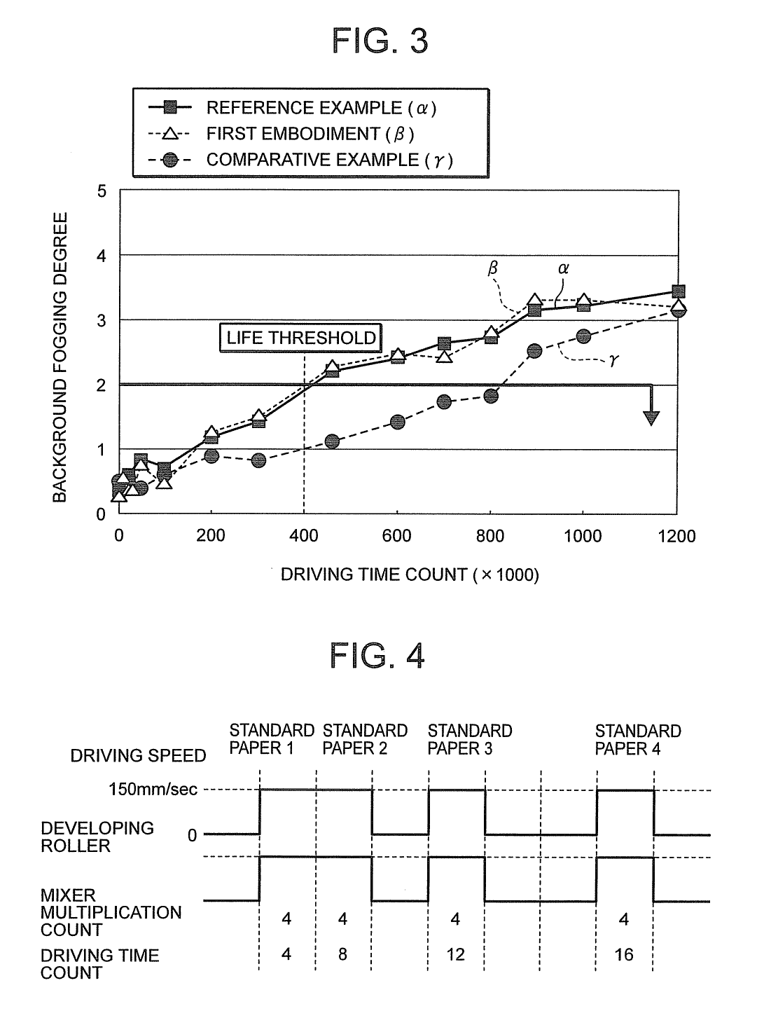

In FIG. 3, the horizontal axis indicates the driving time count of the developing device 14Y of yellow (Y), and the vertical axis indicates the background fogging degree. When the background fogging degree of the toner image is actually measured while printing is performed on five pieces of A4 size standard paper, a solid line α (reference example) indicated by ▪ in FIG. 3 is obtained. As shown in FIG. 4, the driving time count of the solid line α is obtained from accumulate the multiplication count. The multiplication count is obtained from multiplies the driving time of the first and the second mixers 56 and 57 as the driving time of the developing device 14Y of yellow (Y) by the count coefficient 4.

The driving time count (400×1000) when the solid line α exceeds the background fogging degree of 2 is set as the life threshold of the developing device 14Y of yellow (Y) and is stored in the memory 110. Also with respect to each of the developing devices 14M, 14C and 14K of magenta (M), cyan (C) and black (K), similarly to the developing device 14Y of yellow (Y), the driving time count as the life threshold is set and is stored in the memory 110.

The memory 110 stores the count coefficient which is set according to the operation of the developing roller 58. In the developing devices 14Y, 14M, 14C and 14K, there is a case where while the first and the second mixers 56 and 57 are being driven at a constant speed, the driving speed of the developing roller 58 is changed, or the driving of the developing roller 58 is stopped. The count coefficient is set according to the operation of the developing roller 58, and is stored in the memory.

### (Setting of the Count Coefficient)

The driving speed of the developing roller 58 is different between the case where printing is performed on standard paper and the case where printing is performed on thick paper, and the traveling distance per unit time of the developing roller 58 varies. When printing is performed on the thick paper, the traveling distance per unit time of the developing roller 58 is ½ of that of the case where printing is performed on the standard paper. The deterioration degree of the developer 51 is influenced by the traveling distance variation per unit time of the developing roller 58 and is changed.

When the traveling distance per unit time of the developing roller 58 is large at the time of driving of the developing devices 14Y, 14M, 14C and 14K, the load applied to the developer becomes large, and the deterioration of the developer 51 proceeds. When the traveling distance per unit time of the developing roller 58 is small at the time of driving of the developing devices 14Y, 14M, 14C and 14K, the load applied to the developer 51 becomes small, and the deterioration of the developer 51 becomes slow.

The count coefficient multiplied to the driving time of the developing device 14Y is set to, for example, 4 for the standard paper in which the traveling distance per unit time of the developing roller 58 is large. The count coefficient is set to 2 for the thick paper in which the traveling distance per unit time of the developing roller 58 is small. Besides, the count coefficient is set to 1 when the developing roller 58 is in a stopped state and the print job is not performed although the first and the second mixers 56 and 57 are driven at a constant speed.

The count coefficient of the case of the thick paper is made smaller than the count coefficient of the case of the standard paper, and the difference in progress of deterioration of the developer 51 between the case where printing is performed on the standard paper and the case where printing is performed on the thick paper is reflected on the judgment of the life of the developer 51. The count coefficient of 4 for the standard paper, the count coefficient of 2 for the thick paper, and the count coefficient of 1 for the stop of the developing roller 58 which are set upped are stored in the memory 110.

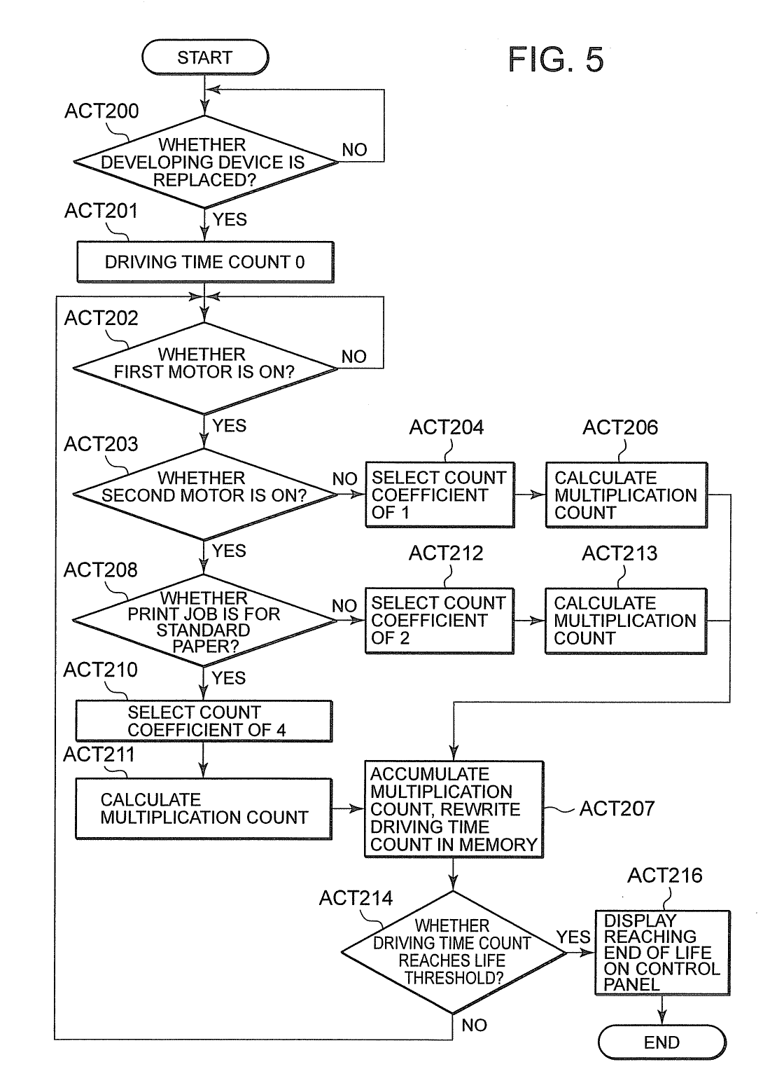

The measurement of the life of the developer 51 of the developing device 14Y of yellow (Y) will be described with reference to a flowchart of FIG. 5. The measurement of the life is started and the developing device 14Y of yellow (Y) is replaced by a new one (Act 200). The driving time count stored in the memory 110 is reset to 0 (Act 201). The driving of the first motor 62 is detected by the mixer management unit 120 (Act 202). When the first and the second mixers 56 and 57 are driven by turning-on of the first motor 62, the on and off management unit 130 detects turning on and off of the second motor 63 (Act 203).

At Act 203, when the second motor 63 is off and the developing roller 58 is stopped, the print job is not performed, and accordingly, the count coefficient of 1 stored in the memory 110 is selected (Act 204). Next, in the arithmetic unit 150, the count coefficient of 1 is multiplied to the driving time of the first and the second mixers 56 and 57 and the multiplication count is calculated (Act 206). The calculated multiplication count is accumulated to the driving time count in the memory 110, and the driving time count in the memory 110 is rewritten (Act 207). Next, advance is made to Act 214.

When the second motor 63 is on at Act 203, the driving speed of the developing roller 58 by the second motor 63 is detected by the speed management unit 140 (Act 208). At Act 208, when the print job is for the standard paper, the count coefficient of 4 stored in the memory 110 is selected (Act 210). Next, in the arithmetic unit 150, the count coefficient of 4 is multiplied to the driving time of the first and the second mixers 56 and 57 to calculate the multiplication count (Act 211), and advance is made to Act 207. At Act 207, the calculated multiplication count is accumulated to the driving time count stored in the memory 110, and the driving time count in the memory 110 is rewritten. Next, advance is made to Act 214.

At Act 208, when the print job is for the thick paper, the count coefficient of 2 stored in the memory 110 is selected (Act 212). Next, in the arithmetic unit 150, the count coefficient of 2 is multiplied to the driving time of the first and the second mixers 56 and 57 to calculate the multiplication count (Act 213), and advance is made to Act 207. At Act 207, the calculated multiplication count is accumulated to the driving time count stored in the memory 110, and the driving time count in the memory 110 is rewritten. Next, advance is made to Act 214.

At Act 214, the judgment unit 160 compares the driving time count with the life threshold (400×1000) in the memory 110. At Act 214, when the driving time count stored in the memory 110 does not reach the life threshold, return to Act 202, and the measurement of the life of the developer 51 is continued.

At Act 214, when the driving time count reaches the life threshold, it is judged that the developer 51 reaches its end of life (Act 216). At Act 216, the control panel 170 displays that the developer 51 reaches its end of life, and the measurement of the life of the developer 51 is ended. The user replaces the developing device 14Y of yellow (Y), in which the developer 51 reaches its end of life, by a new one.

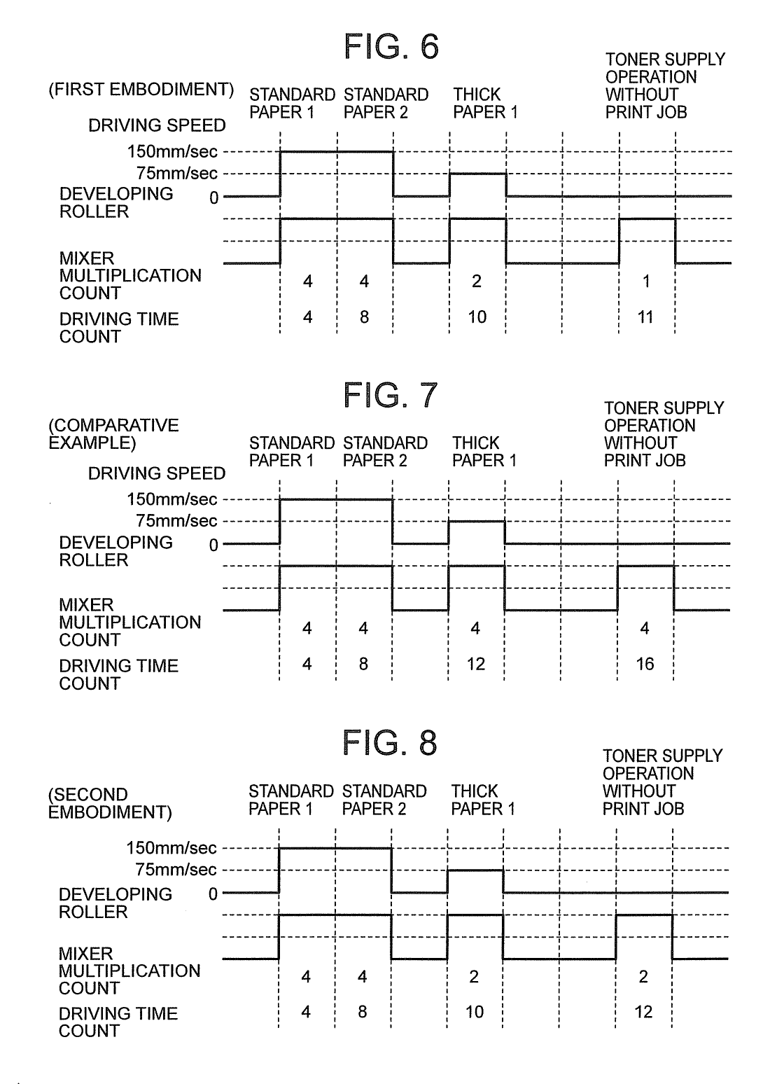

FIG. 6 shows a calculation example of actual driving time count in accordance with the flowchart of FIG. 5. FIG. 6 shows the calculation example of the driving time count including a case where a print job is performed while standard paper and thick paper are changed at random and a case which the print job is not performed in which only the first and the second mixers 56 and 57 are driven. With respect to the print job on the standard paper, the count coefficient of 4 is multiplied to the driving time. With respect to the print job on the thick paper, the count coefficient of 2 is multiplied to the driving time. With respect to the case which the print job is not performed, the count coefficient of 1 is multiplied to the driving time. The driving time count obtained by accumulating the multiplication count becomes 11.

Besides, in accordance with the flowchart of FIG. 5 of this embodiment, the count coefficient is changed according to the operation of the developing roller 58, the driving time count is calculated, and the actual life test of the developing device 14Y of yellow (Y) is performed. As a result, a dotted line β indicated by Δ in FIG. 3 is obtained. In the life test, after the developing device 14Y of yellow (Y) is replaced by a new one, JIS A4 size standard paper and thick paper are alternately used, and a print job is performed. In one print job, printing of five sheets is performed, and each time the printing of five sheets is performed, the background fogging degree of a toner image is measured.

The dotted line β indicates almost the same transit as the solid line α of the reference example. In the dotted line β, when the driving time count reaches (400×1000) of the life threshold, the state is such that the background fogging degree of the obtained toner image reaches 2. Even if the operation of the developing roller 58 in the print job is changed, the measurement accuracy of the life of the developer 51 is hardly shifted from the reference example, and the excellent life measurement accuracy can be obtained.

Incidentally, as a comparative example, in the life test, the count coefficient is made constant irrespective of the operation of the developing roller 58, the driving time count is calculated, and the test is performed. FIG. 7 shows the driving time count of the comparative example. In FIG. 7, the count coefficient of 4 is multiplied to the driving time in all cases including a case of a print job for standard paper, a case of a print job for thick paper, and a case which the print job is not performed. The driving time count obtained by accumulating the multiplication count is 16.

In the life test of the comparative example, a dotted line γ indicated by in FIG. 3 is obtained. In the dotted line γ of the comparative example, although the driving time count reaches (400×1000) of the life threshold, the background fogging degree of a toner image keeps almost 1, and actually, the developer does not reach its end of life. In the dotted line γ of the comparative example, in the driving of the first and the second mixers 56 and 57, the count coefficient is made constant although the operation of the developing roller 58 is changed. Accordingly, the measurement accuracy of the life of the developer is significantly shifted from the reference example. In the comparative example, the measurement accuracy of the life of the developer is reduced.

In the first embodiment, the count coefficient multiplied to the driving time of the first and the second mixers 56 and 57 is changed according to the operation of the developing roller 58, and the driving time count is calculated. When the count coefficient is changed and the driving time count is calculated, regardless of irrespective of the difference in progress of deterioration of the developer 51 due to the difference in the operation of the developing roller 58. The replacement timing caused by the life of the developer 51 can be accurately judged. The developer which does not reach its end of life and can be used is not wastefully replaced.

Next, a second embodiment will be described. The second embodiment is different from the first embodiment in a count coefficient corresponding to an operation of a developing roller. The others are the same as the first embodiment. In the second embodiment, the same structure as that explained in the first embodiment is denoted by the same reference numerals and signs, and its detailed description will be omitted.

In this embodiment, with respect to the case of a state which the print job is not performed in which a developing roller 58 is stopped at the time of driving of a first and a second mixers 56 and 57, a dedicated count coefficient is not set. A count coefficient for standard paper or a count coefficient for thick paper is used also as the count coefficient for the case of the state which the print job is not performed.

As the state which the print job is not performed, for example, there is a case where toner supply is performed after the print job is finished. However, the frequency thereof is not high, and an influence is hardly exerted on the measurement of the life of the developer. From this, as the count coefficient for the case which the print job is not performed, the count coefficient for the standard paper or the count coefficient for the thick paper is used. Accordingly, the count coefficient of 4 for the standard paper and the count coefficient of 2 for the thick paper are stored in the memory 110.

For example, when the count coefficient of 2 for the thick paper is used also as the count coefficient for the case which the print job is not performed, the count coefficient of 2 is selected at Act 204 of FIG. 5. At Act 206, the count coefficient of 2 is multiplied to the driving time of the first and the second mixers 56 and 57, and the multiplication count for the case which the print job is not performed is calculated.

FIG. 8 shows a calculation example of an actual driving time count. Similarly to FIG. 6 of the first embodiment, FIG. 8 shows the calculation example of the driving time count including the case where the print job is performed while standard paper and thick paper are changed at random, and the case which the print job is not performed in which only the first and the second mixers 56 and 57 are driven. With respect to the print job on the standard paper, the count coefficient of 4 is multiplied to the driving time. With respect to the print job on the thick paper and the case which the print job is not performed, the count coefficient of 2 is multiplied to the driving time. The driving time count obtained by accumulating the multiplication count becomes 12.

As compared with the first embodiment, the multiplication count for the case which the print job is not performed is increased by one per unit time. However, the rate of the increase hardly influences the life threshold (400×1000). Even if the count coefficient of 2 for the thick paper is used also as the count coefficient for the case which the print job is not performed, the excellent life measurement accuracy almost equal to the first embodiment can be obtained.

Incidentally, in the second embodiment, the count coefficient of 4 for the standard paper may be used also as the count coefficient for the case which the print job is not performed.

The invention is not limited to the above embodiments, but various modifications can be made within the scope of the invention. For example, the developing device may be mounted in a monochrome image forming apparatus. The coefficient multiplied to the driving time of the developing device is not limited. It is sufficient if the coefficient is such a value that the difference in deterioration of the developer due to the operation of the developing member can be reflected on the actual life of the developer. The image forming speed of the image forming apparatus is not limited. The image forming apparatus may be an apparatus in which the image forming speed is changed to, for example, three speeds. When the image forming speed is changed to the three speeds of a standard speed, a high speed two times higher than the standard speed, and a low speed of half the standard speed, the coefficient for the case of the high speed may be 6, the coefficient for the case of the standard speed may be 4, and the coefficient for the case of the low speed may be 2. The image forming apparatus is not limited to the printer, but may be a copy machine or a facsimile. The structure of the image forming apparatus may be such that a toner image formed on an image carrier is directly transferred to a sheet.

What is claimed is:

1. A measuring apparatus of mixing time of developer, comprising:
a mixing member to mix the developer in a developing container;
a developing member that has a plurality of driving speeds and supplies the developer in the developing container to an image carrier; and
an arithmetic member to multiply a driving time of the mixing member by a coefficient which is set correspondingly to an operation of the developing member in a period when the mixing member is driven, and to accumulate a multiplication count obtained by multiplication of the coefficient.

2. The apparatus of claim 1, wherein a first driving member drives the mixing member and a second driving member drives the developing member.

3. The apparatus of claim 1, wherein when the developing member is driven, the coefficient is set correspondingly to the driving speed of the developing member.

4. The apparatus of claim 3, wherein when the developing member is stopped, the coefficient is set correspondingly to the stop of the developing member.

5. The apparatus of claim 4, wherein the coefficient which is set correspondingly to the driving speed of the developing member is used also as the coefficient which is set correspondingly to the stop of the developing member.

6. The apparatus of claim 1, wherein the coefficient is set in proportion to a distance for which the developing member travels while the mixing member is driven.

7. The apparatus of claim 1, wherein the developing container includes a developer discharge member to discharge a part of the developer.

8. An image forming apparatus comprising:
an image carrier;
a mixing member to mix a developer in a developing container;
a developing member that has a plurality of driving speeds and supplies the developer in the developing container to the image carrier;
an arithmetic member to multiply a driving time of the mixing member by a coefficient which is set correspondingly to an operation of the developing member in a period when the mixing member is driven, and to accumulate a multiplication count obtained by multiplication of the coefficient; and
a judgment member to judge a life of the developer from an accumulated count obtained by accumulation of the multiplication count.

9. The apparatus of claim 8, wherein a first driving member drives the mixing member and a second driving member drives the developing member.

10. The apparatus of claim 8, wherein when the developing member is driven, the coefficient is set correspondingly to the driving speed of the developing member.

11. The apparatus of claim 10, wherein when the developing member is stopped, the coefficient is set correspondingly to the stop of the developing member.

12. The apparatus of claim 11, wherein the coefficient which is set correspondingly to the driving speed of the developing member is used also as the coefficient which is set correspondingly to the stop of the developing member.

13. The apparatus of claim 8, wherein the coefficient is set in proportion to a distance for which the developing member travels while the mixing member is driven.

14. The apparatus of claim 8, wherein the judgment member judges that the developer reaches its end of life when the accumulated count reaches a life threshold for judgment of the life of the developer.

15. The apparatus of claim 8, wherein the developing container includes a developer discharge member to discharge a part of the developer.

16. A measuring method of mixing time of developer, comprising:
multiplying a driving time of a mixing member by a coefficient which is set correspondingly to an operation of a developing member in a period when the mixing member in a developing container is driven; and
accumulating a multiplication count obtained by multiplying the driving time of the mixing member by the coefficient.

17. The method of claim 16, wherein driving of the mixing member and driving of the developing member are separated.

18. The method of claim 16, wherein when the developing member is driven, the coefficient is set correspondingly to a driving speed of the developing member.

19. The method of claim 18, wherein when the developing member is stopped, the coefficient is set correspondingly to the stop of the developing member.

20. The method of claim 19, wherein the coefficient which is set correspondingly to the driving speed of the developing member is used also as the coefficient which is set correspondingly to the stop of the developing member.

21. The method of claim 16, wherein the coefficient is set in proportion to a distance for which the developing member travels while the mixing member is driven.
